(19) United States
(12) Patent Application Publication
(10) Pub. No.: US 2024/0394519 A1
(43) Pub. Date: Nov. 28, 2024

(54) APPARATUS AND METHOD FOR PROVIDING BENCHMARK PREDICTION RESULT OF ARTIFICIAL INTELLIGENCE BASED MODEL

(71) Applicant: NOTA, INC., Daejeon (KR)

(72) Inventors: Sanggeon PARK, Seoul (KR); Seongun HONG, Seoul (KR)

(21) Appl. No.: 18/656,223

(22) Filed: May 6, 2024

(30) Foreign Application Priority Data
May 24, 2023 (KR) 10-2023-0066852

(51) Int. Cl. G06N 3/048

(52) U.S. Cl. CPC G06N 3/048; G06N 7/00

(57) ABSTRACT

According to an embodiment of the present disclosure, a method for providing a benchmark prediction result, performed by a computing apparatus is disclosed. The method includes obtaining a benchmark query specifying a target of a benchmark. The method includes determining at least one target block to be used to obtain the benchmark prediction result corresponding to the benchmark query among pre-stored blocks based on the benchmark query. The blocks comprise a node identifying a function or an operation constituting a model, and an edge connecting nodes. The method includes obtaining the benchmark prediction result corresponding to the benchmark query, using a benchmark result related to the determined at least one target block.

### CROSS-REFERENCE TO RELATED APPLICATIONS

This application claims priority to and the benefit of Korean Patent Application No. 10-2023-0066852 filed in the Korean Intellectual Property Office on May 24, 2023, the entire contents of which are incorporated herein by reference.

### BACKGROUND

### Technical Field

The present disclosure relates to artificial intelligence technology, and more particularly, to benchmark of a model.

### Description of the Related Art

As the demand for edge technology or edge artificial intelligence technology that can perform direct calculations on a network terminal such as personal computers, smart phones, cars, wearable devices, and robots increase, the research and developments of models that take hardware resources into account are made.

As the importance of hardware increases in the field of artificial intelligence technology along with the development of edge technology, sufficient knowledge is required not only about the model itself but also about the various hardware on which artificial intelligence-based models will be executed. For example, even if there is a model with excellent performance in a specific domain, inference performance for these models can be different for each hardware where the model is to be executed. There can also be a situation in which a model having optimal performance is not supported in specific hardware in which a service is to be provided in a specific domain. Accordingly, in order to determine the artificial intelligence-based model suitable for the service to be provided and hardware suitable for the artificial intelligence-based model together, high levels of background knowledge and vast amounts of resources for the artificial intelligence technology and hardware technology can be required.

US patent publication No. 2022/0121927 discloses providing a group of neural networks for processing data in a plurality of hardware environments.

### BRIEF SUMMARY

The present disclosure has been made in an effort to efficiently provide a benchmark result of a specific model in a specific node. The present disclosure can effectively and accurately provide a benchmark result or a benchmark prediction result of an artificial intelligence-based model. The present disclosure can improve a user experience with a benchmark result of an artificial intelligence-based model.

However, technical objects of the present disclosure are not restricted to a technical object mentioned above, and other technical objects not mentioned will be able to be apparently appreciated by those skilled in the art.

An exemplary embodiment of the present disclosure provides a method for providing a benchmark prediction result, performed by a computing apparatus. The method can comprise: obtaining a benchmark query specifying a target of a benchmark, determining at least one target block to be used to obtain the benchmark prediction result corresponding to the benchmark query among pre-stored blocks based on the benchmark query, wherein the blocks comprise a node identifying a function or an operation constituting a model, and an edge connecting nodes, and obtaining the benchmark prediction result corresponding to the benchmark query, using a benchmark result related to the determined at least one target block.

In an exemplary embodiment, the benchmark query identifies a target area within a target model to be benchmarked, and the benchmark prediction result comprises predicted performance information corresponding to the identified target area when a benchmark is performed on a target device.

In an exemplary embodiment, the benchmark query identifies a start node and an end node within a target model to be benchmarked, and the benchmark prediction result comprises predicted performance information corresponding to a target area defined by the identified start node and the identified end node when the benchmark is performed on a target device.

In an exemplary embodiment, the benchmark query comprises a node identifier and an edge identifier within a target model to be benchmarked, and the benchmark prediction result comprises predicted performance information corresponding to a target area defined by the node identifier and the edge identifier when the benchmark is performed on a target device.

In an exemplary embodiment, the determining the at least one target block comprises: determining a query node and a query edge included in the benchmark query, determining a target node corresponding to the query node and a target edge corresponding to the query edge, and determining a block comprising the target node and the target edge among the pre-stored blocks, as a target block to be used to obtain the benchmark prediction result corresponding to the benchmark query.

In an exemplary embodiment, the determining the at least one target block comprises: determining similarity between each of the pre-stored blocks and a query node and a query edge included in the benchmark query, and determining the at least one target block to be used to obtain the benchmark prediction result corresponding to the benchmark query, by assigning priority to the pre-stored blocks based on the determined similarity.

In an exemplary embodiment, the similarity is determined at least partially based on a connection relationship between nodes and an attribute of each node.

In an exemplary embodiment, the determining the at least one target block comprises: determining whether a configuration of a node and an edge corresponding to a query configuration of a query node and a query edge included in the benchmark query exists in a single block of the pre-stored blocks, determining a block comprising the configuration corresponding to the query configuration, as a target block to be used to obtain the benchmark prediction result corresponding to the benchmark query, when the configuration corresponding to the query configuration exists in the single block of the pre-stored blocks, and determining a combination of two or more blocks for generating the configuration corresponding to the query configuration among the pre-stored blocks, when the configuration corresponding to the query configuration does not exist in the single block of the pre-stored blocks.

In an exemplary embodiment, the obtaining the benchmark prediction result corresponding to the benchmark query comprises, obtaining the benchmark prediction result corresponding to the benchmark query by combining benchmark results assigned to each of two or more blocks.

In an exemplary embodiment, the determining the at least one target block comprises, determining a block comprising a target node having an attribute interchangeable with a query attribute of the query node among the pre-stored blocks, as a target block to be used to obtain the benchmark prediction result corresponding to the benchmark query, when a configuration of a node and an edge corresponding to a query configuration of a query node and a query edge included in the benchmark query does not exist in the pre-stored blocks.

In an exemplary embodiment, the target node having the attribute interchangeable with the query attribute of the query node among the pre-stored blocks corresponds to a node having data of a shape quantitatively interchangeable with a data shape of the query node.

In an exemplary embodiment, the obtaining the benchmark prediction result corresponding to the benchmark query comprises: determining a substitution value between the target node within the determined target block and the query node, and obtaining the benchmark prediction result corresponding to the benchmark query, by applying the substitution value to a benchmark result assigned to the target block.

In an exemplary embodiment, the substitution value comprises a difference value or ratio value between a quantitative size value corresponding to a data shape of the query node and a quantitative size value corresponding to a data shape of the target node.

In an exemplary embodiment, each of the pre-stored blocks comprises at least one sub block, the number of the at least one sub block within a single block corresponds the number of selectable cases or combinable cases for N nodes included in the single block, and N is a selected (or predetermined) natural number.

In an exemplary embodiment, the pre-stored blocks are obtained based on: obtaining a plurality of nodes constituting an inputted model, extracting an attribute for each of the obtained nodes, and generating a block comprising at least one node among the plurality of nodes.

In an exemplary embodiment, the generating the block comprises, generating the block comprising at least one node among the plurality of nodes, based on a manner in which at least one node in the generated block belongs to a subset of the obtained nodes.

In an exemplary embodiment, the attribute comprises at least one of: an input attribute comprising previous connection information of a node, an identifier of a node and a data shape of a node; an output attribute comprising next connection information of a node, an identifier of a node and a data shape of a node; and an operation attribute comprising at least one of: a data shape of a node, a weight of a node, a bias of a node, a stride of a node, a pad of a node, a dilation of a node, and group information within a node.

In an exemplary embodiment, a benchmark result of each of the plurality of blocks for each of a plurality of devices is assigned to each of the plurality of blocks, and the benchmark result comprises latency information.

In an exemplary embodiment, a computer program stored in a non-transitory computer readable medium is disclosed. The computer program allows a computing apparatus to perform following operations to provide a benchmark prediction result when executed by the computing apparatus, and wherein the operations comprise: obtaining a benchmark query specifying a target of a benchmark, determining at least one target block to be used to obtain the benchmark prediction result corresponding to the benchmark query among pre-stored blocks based on the benchmark query, wherein the blocks comprise a node identifying a function or an operation constituting a model, and an edge connecting nodes, and obtaining the benchmark prediction result corresponding to the benchmark query, using a benchmark result related to the determined at least one target block.

In an exemplary embodiment, a computing apparatus for providing a benchmark prediction result is disclosed. The computing apparatus comprises at least one processor, and a memory. The at least one processor obtains a benchmark query specifying a target of a benchmark, determines at least one target block to be used to obtain the benchmark prediction result corresponding to the benchmark query among pre-stored blocks based on the benchmark query, wherein the blocks comprise a node identifying a function or an operation constituting a model, and an edge connecting nodes, and obtains the benchmark prediction result corresponding to the benchmark query, using a benchmark result related to the determined at least one target block.

According to an exemplary embodiment of the present disclosure, a benchmark prediction result can be provided efficiently and/or accurately.

### BRIEF DESCRIPTION OF THE SEVERAL VIEWS OF THE DRAWINGS

FIG. 1 schematically illustrates a block diagram of a computing device according to an exemplary embodiment of the present disclosure.

FIG. 2 illustrates an exemplary structure of an artificial intelligence based model according to an exemplary embodiment of the present disclosure.

FIG. 3 is an exemplary schematic view for a system for providing a benchmark prediction result according to an exemplary embodiment of the present disclosure.

FIG. 4 exemplarily illustrates a method for providing a benchmark prediction result according to an exemplary embodiment of the present disclosure.

FIG. 5 exemplarily illustrates a method for generating a block used for providing a benchmark prediction result according to an exemplary embodiment of the present disclosure.

FIG. 6 exemplarily illustrates a data structure of the block according to an exemplary embodiment of the present disclosure.

FIG. 7 exemplarily illustrates a data structure of the block according to an exemplary embodiment of the present disclosure.

FIG. 8 is a schematic view of a computing environment according to an exemplary embodiment of the present disclosure.

### DETAILED DESCRIPTION

Various exemplary embodiments will be described with reference to drawings. In the specification, various descriptions are presented to provide appreciation of the present disclosure. Prior to describing detailed contents for carrying out the present disclosure, it should be noted that configurations not directly associated with the technical gist of the present disclosure are omitted without departing from the technical gist of the present disclosure. Further, terms or words used in this specification and claims should be interpreted as meanings and concepts which match the technical spirit of the present disclosure based on a principle in which the inventor can define appropriate concepts of the terms in order to describe his/her disclosure by a best method.

“Module,” “system,” and the like which are terms used in the specification refer to a computer-related entity, hardware, firmware, software, and a combination of the software and the hardware, or execution of the software, and interchangeably used. For example, the module may be a processing procedure executed on a processor, the processor, an object, an execution thread, a program, application and/or a computing device, but is not limited thereto. One or more modules may reside within the processor and/or a thread of execution. The module may be localized in one computer. One module may be distributed between two or more computers. Further, the modules may be executed by various computer-readable media having various data structures, which are stored therein. The modules may perform communication through local and/or remote processing according to a signal (for example, data from one component that interacts with other components and/or data from other systems transmitted through a network such as the Internet through a signal in a local system and a distribution system) having one or more data packets, for example.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” and “at least one” used in this specification designates and includes all available combinations of one or more items among enumerated related items. For example, the term “at least one of A or B” or “at least one of A and B” should be interpreted to mean “a case including only A,” “a case including only B,” and “a case in which A and B are combined.”

Further, it should be appreciated that the term “comprise/include” and/or “comprising/including” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

Those skilled in the art need to recognize that various illustrative logical components, blocks, means, logics, and algorithms described in connection with the exemplary embodiments disclosed herein may be additionally implemented as electronic hardware, computer software, or combinations of both sides.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

Terms expressed as N-th such as first, second, or third in the present disclosure are used to distinguish at least one entity. For example, entities expressed as first and second may be the same as or different from each other.

The term “benchmark” used in the present disclosure may mean an operation of executing or testing the model in the device or an operation of measuring the performance for the device of the model. A benchmark result or benchmark result information in the present disclosure may include information obtained according to the benchmark or information obtained by processing the information obtained according to the benchmark. In the present disclosure, a benchmark prediction result or benchmark prediction result information may mean a benchmark result predicted when the model is executed in the device. For example, the benchmark prediction result may correspond to a benchmark result obtained without executing the model in the device (that is, without measuring the performance).

The term “model” used in the present disclosure may be used as a meaning that encompasses the artificial intelligence based model, the artificial intelligence model, the computation model, the neural network, a network function, and the neural network. In an exemplary embodiment, the model may mean a model file, identification information of the model, an execution configuration of the model, and a framework of the model. For example, TensorRT, TFLite, and/or Onnx Runtime may correspond to the model.

The term “device” used in the present disclosure may correspond to hardware or hardware identification information in which the benchmark for the model is to be performed. The hardware may be used as a meaning that encompasses physical hardware, virtual hardware, hardware which is impossible to be accessed through the network from the outside, hardware which is impossible to confirm externally, and/or hardware which is confirmed in a cloud. For example, the device in the present disclosure may include various types of hardware such as RaspberryPi, Coral, Jetson-Nano, AVH RasberryPi, and Mobile.

A node in the present disclosure may be used to mean a component constituting the model. For example, one model may include a plurality of nodes, and the plurality of nodes may be connected to each other through edges. An operation of the model may be performed through calculations of the plurality of nodes. For example, the node may be used interchangeably with an operator or a layer of the model. As an example, a convolutional layer may become an example for the node in the artificial intelligence model.

A benchmark query in the present disclosure may correspond to input data for requesting a benchmark result or a benchmark prediction result. As an example, the benchmark query may include information on a model to be benchmarked and a device in which the model is to be executed. As an example, the benchmark query may include requesting a specific area in the model to be benchmarked and performance information for the area. As an example, the benchmark query may be obtained based on a user input.

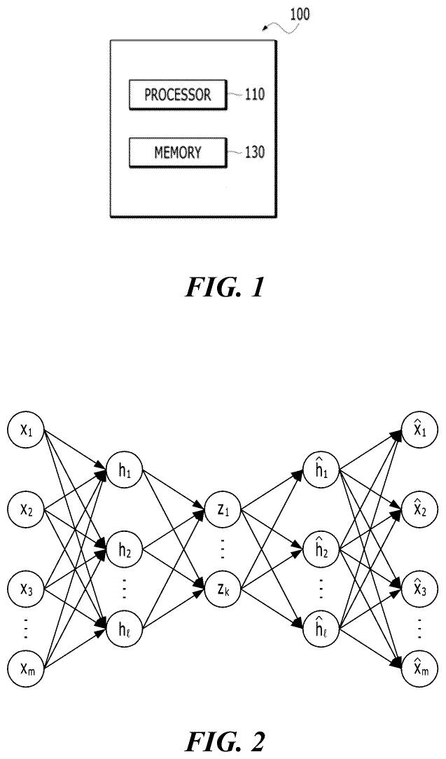

FIG. 1 schematically illustrates a block configuration diagram of a computing device 100 according to an exemplary embodiment of the present disclosure.

According to the exemplary embodiment of the present disclosure, a computing device 100 may include a processor 110 and a memory 130.

A configuration of the computing device 100 illustrated in FIG. 1 is only an example shown through simplification. In an exemplary embodiment of the present disclosure, the computing device 100 may include other components for performing a computing configuration of the computing device 100 and only some of the disclosed components may constitute the computing device 100.

The computing device 100 in the present disclosure may be used as a meaning that encompass any type of server and any type of terminal.

In the present disclosure, the computing device 100 may mean any type of component constituting a system for implementing exemplary embodiments of the present disclosure.

The components of the computing device 100 illustrated in FIG. 1 may be exemplary and some components may be excluded, or an additional component may be included in the computing device 100. As an example, when the computing device 100 includes a user terminal, an output unit (not illustrated) and an input unit (not illustrated) may be included in a scope of the computing device 100.

In an exemplary embodiment, the computing device 100 may mean a device that manages and/or performs the benchmark for a plurality of devices of a specified artificial intelligence-based model in communication with a plurality of devices. For example, the computing device 100 may refer to a device for managing a device farm. In another example, the computing device 100 may also correspond to the device farm.

In an exemplary embodiment, the computing device 100 may interact with an input from a user. For example, the computing device 100 may generate a learning model, generate a compressed model, and generate download data for deploying the model. For example, the computing device 100 may generate or obtain a benchmark prediction result corresponding to a benchmark query requested from the user.

In an exemplary embodiment, the computing device 100 may manage and/or perform the benchmark for the plurality of devices the artificial intelligence-based model.

In an exemplary embodiment, the computing device 100 may also mean a device that generates the learning model through modeling for an input dataset, generates a lightweight model through compression for an input model, and/or generates download data so as to deploy the input model in a specific node. In the present disclosure, deploy or deployment may mean any type of activity which enables using software (e.g., model). For example, the deploy or deployment may be interpreted as an overall process customized according to specific requirements or characteristics of the model or node. An example for the deploy or deployment may include release, installation and activation, deactivation, removal, update, built-in update, adaptation, and/or version tracking.

According to an exemplary embodiment of the present disclosure, the computing device 100 may obtain a benchmark prediction result corresponding to a benchmark query in response to the benchmark query. For example, the computing device 100 may obtain the benchmark query from a user input that specifics a target of a benchmark, determine at least one target block to be used for obtaining the benchmark prediction result corresponding to the benchmark query among a plurality of prestored blocks based on the benchmark query, and obtain the benchmark prediction result corresponding to the benchmark query by using the benchmark result related to at least one determined target block.

According to an exemplary embodiment of the present disclosure, the computing device 100 may perform a preliminary task for obtaining the benchmark prediction result. For example, the preliminary task may include a task of dividing the components of the model, and generating performance information for the divided models. For example, the computing device 100 may combine the nodes constituting the model by the unit of the block, and generate and store the benchmark result based on the block. For example, the computing device 100 may determine a query node and a query edge included in the benchmark query, determine a target node corresponding to the query node and a target edge corresponding to the query edge, and determine a block including the target node and the target edge among a plurality of prestored blocks as a target block to be used for obtaining a benchmark prediction result corresponding to the benchmark query.

In an additional exemplary embodiment, the computing device 100 may determine whether to convert an artificial intelligence-based model based on model type information of the artificial intelligence-based model, which is input for the benchmark and target type information identifying a model type to be benchmarked, and provide a candidate device list including candidate devices determined based on the target type information, and determine, based on input data for selecting at least one target device in the candidate device list, the at least one target device, and provide a benchmark result obtained as a target model obtained according to whether to convert the artificial intelligence-based model is executed in the at least one target device. For example, the computing device 100 may obtain input data including an inference task and a dataset, determine a target model to be benchmarked for the inference task and at least one target device in which the inference task of the target model is to be executed, and generate a benchmark result obtained as the target model is executed in at least one target device. As an example, the benchmark result, may be generate by the unit of the node constituting the model or by the unit of the block constituted by the node and the edge.

In an additional exemplary embodiment, the computing device 100 may receive, from another computing device including a plurality of modules that performs different operations related to the artificial intelligence-based model, module identification information indicating which module among the plurality of modules of another computing device is to trigger a benchmark operation of the computing device 100, and provide the benchmark result to another computing device based on the module identification information. Here, the benchmark result provided to another computing device may vary depending on the module identification information.

In an additional exemplary embodiment of the present disclosure, the computing device 100 may also obtain a result of performing the benchmark or a benchmark prediction result from another computing device or an external entity.

In an additional exemplary embodiment of the present disclosure, the computing device 100 may also obtain a result of converting the model from another computing device or an external entity (e.g., a converting device).

In an exemplary embodiment, the processor 110 may be constituted by at least one core and may include processors for data analysis and/or processing, which include a central processing unit (CPU), a general purpose graphics processing unit (GPGPU), a tensor processing unit (TPU), and the like of the computing device 100.

The processor 110 may read a computer program stored in the memory 130 to provide the benchmark result according to an exemplary embodiment of the present disclosure.

According to an exemplary embodiment of the present disclosure, the processor 110 may also perform a computation for learning a neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of the plurality of computing devices may be used together to process the learning of the network function and the data classification using the network function. Further, the computer program executed in the computing device 100 according to an exemplary embodiment of the present disclosure may be a CPU, GPGPU, or TPU executable program.

Additionally, the processor 110 may generally process an overall operation of the computing device 100. For example, the processor 110 processes data, information, signals, and the like input or output through the components included in the computing device 100 or drives the application program stored in a storage unit to provide information or a function appropriate for the user.

According to an exemplary embodiment of the present disclosure, the memory 130 may store any type of information generated or determined by the processor 110 or any type of information received by the computing device 100. According to an exemplary embodiment of the present disclosure, the memory 130 may be a storage medium that stores computer software which allows the processor 110 to perform the operations according to the exemplary embodiments of the present disclosure. Therefore, the memory 130 may mean computer-readable media for storing software codes required for performing the exemplary embodiments of the present disclosure, data which become execution targets of the codes, and execution results of the codes.

According to an exemplary embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the memory 130 used in the present disclosure is not limited to the examples.

In the present disclosure, the communication unit (not illustrated) may be configured regardless of communication modes such as wired and wireless modes and constituted by various communication networks including a personal area network (PAN), a wide area network (WAN), and the like. Further, the network unit 150 may operate based on known World Wide Web (WWW) and may adopt a wireless transmission technology used for short-distance communication, such as infrared data association (IrDA) or Bluetooth.

The computing device 100 in the present disclosure may include any type of user terminal and/or any type of server. Therefore, the exemplary embodiments of the present disclosure may be performed by the server and/or the user terminal.

In an exemplary embodiment, the user terminal may include any type of terminal which is capable of interacting with the server or another computing device. The user terminal may include, for example, a mobile phone, a smart phone, a laptop computer, personal digital assistants (PDA), a slate PC, a tablet PC, and an ultrabook.

In an exemplary embodiment, the server may include, for example, any type of computing system or computing device such as a microprocessor, a mainframe computer, a digital processor, a portable device, and a device controller.

In an exemplary embodiment, the server may store and manage the benchmark result, the benchmark prediction result, the candidate device list, performance information of devices, latency information between the device and the model, block configuration information, block-wise performance information, node and edge information in the block, and/or converting result information. For example, the server may include a storage unit (not illustrated) for storing the information. The storage unit may be included in the server, or may be present under the management of the server. As another example, the storage unit may also be present outside the server, and implemented in a form which is capable of communicating with the server. In this case, the storage unit may be managed and controlled by another external server different from the server. As another example, the storage unit may also be present outside the server, and implemented in a form which is capable of communicating with the server. In this case, the storage unit may be managed and controlled by another external server different from the server.

FIG. 2 illustrates an illustrative structure of an artificial intelligence-based model according to an exemplary embodiment of the present disclosure.

Throughout the present disclosure, the model, the artificial intelligence model, the artificial intelligence-based model, the operation model, and the neural network, the network function, and the neural network may be used interchangeably.

The artificial intelligence-based model in the present disclosure may include models which are utilizable in various domains, such as a model for image processing such as object segmentation, object detection, and/or object classification, a model for text processing such as data prediction, text semantic inference and/or data classification, etc.

The neural network may be generally constituted by an aggregate of calculation units which are mutually connected to each other, which may be called “node”. The nodes may also be called neurons. The neural network is configured to include one or more nodes. The nodes (or neurons) constituting the neural networks may be mutually connected to each other by one or more links.

The node in the artificial intelligence-based model may be used to mean a component that constitutes the neural network, and for example, the node in the neural network may correspond to the neuron.

In the neural network, one or more nodes connected through the link may relatively form a relationship between an input node and an output node. Concepts of the input node and the output node are relative and a selected (or predetermined) node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is selected (or predetermined) for description and the order of the layer in the neural network may be defined by a method different from the aforementioned method. For example, the layers of the nodes may be defined by the distance from a final output node.

In an exemplary embodiment of the present disclosure, the set of the neurons or the nodes may be defined as the expression “layer”.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. That is, photographs, text, video, voice, protein sequence structure, genetic sequence structure, peptide sequence structure, and/or potential structure of music (e.g., what objects are in the photo, what is the content and emotions of the text, what contents and emotions of the voice, etc.) may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in a clustering model in the present disclosure may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an exemplary embodiment of the present disclosure, a computer readable medium is disclosed, which stores a data structure including the benchmark result and/or the artificial intelligence based model. The data structure may be stored in a storage unit (not illustrated) in the present disclosure, and executed by the processor 110 and transmitted and received by a communication unit (not illustrated).

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include selected (or predetermined) components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include selected (or predetermined) other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node”. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

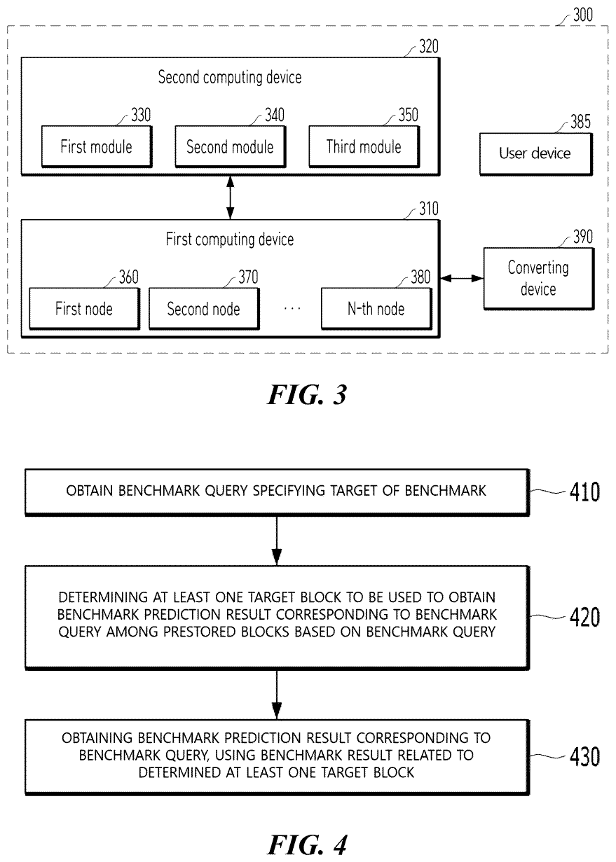

FIG. 3 is an exemplary schematic view for a system 300 for providing a benchmark prediction result according to an exemplary embodiment of the present disclosure.

In an exemplary embodiment, the system 300 may correspond to the computing device 100. In another exemplary embodiment, a first computing device 310, a second computing device 320, or a user device 385 may also correspond to the computing device 100.

In an exemplary embodiment, the first computing device 310 may include or manage a first device 360, a second device 370, . . . , an N-th device 380. As an example, the first computing device 310 may serve as the device farm that performs the benchmark for each of the plurality of devices.

In an exemplary embodiment, the second computing device 320 may include a plurality of modules that performs different operations related to the artificial intelligence-based model. For example, the second computing device 320 may include a first module 330, a second module 340, and a third module 350. In an exemplary embodiment, the first module 330 may generate a learning model based on an input dataset. The second module 340 compresses the input model to generate a lightweight model. The third module 350 may generate download data for deploying the input model in at least one target node. In the example of FIG. 3, three modules are taken as an example, but it will be appreciated by those skilled in the art that various numbers of modules may be included in the second computing device 320 according to an implementation aspect.

In an exemplary embodiment, a plurality of modules 330, 340, and 350 may generate outputs of respective modules by utilizing a benchmark result by different schemes. For example, the first module 330 may generate a learning model (or block) based on the input dataset. The first module may use the benchmark result for determining a target device which is to benchmark the learning model (or block). The first module 330 may use the benchmark result in order to confirm a performance when the learning model (or block) is executed at the target device. The first module 330 may use the benchmark result for generating the learning model (or block) or a re-learning model (or block). The first module 330 may use the benchmark result for determining the type of learning model or re-learning model corresponding to the dataset. The benchmark result may be used to evaluate the performance of the learning model (or block) output from the first module 330. The performance of the learning model (or block) output from the first module 330 may include a memory footprint, a latency, power consumption, and/or node information (an execution configuration of the node, a processor, and/or a RAM size).

For example, the second module 340 compresses the input model (or block) to generate the lightweight model. The second module 340 may use the benchmark result for determining compression setting data for the input model (or block).

For example, the third module 350 may generate download data for deploying the input model (or block) in at least one target device. The third model 350 may use the benchmark result for generating the download data or converting data into a data type supported by the target device. The third module 350 may use the benchmark result for checking which degree of performance the input model (or block) shows in a device which has a specification which is similar to a specification of a node desired by the user as much as possible.

In an exemplary embodiment, the first computing device 310 and the second computing device 320 interacts with each other to provide the benchmark result or the benchmark prediction result to the user device 385. For example, the first computing device 310 may provide a benchmark result or a benchmark prediction result required for the operation of the second computing device 320 to the second computing device 320 in response to a request of the second computing device 320.

In an exemplary embodiment, in FIG. 3, the first computing device 310 is expressed as a separate entity outside the second computing device 320, but the first computing device 310 and the second computing device 320 may also operate as an integrated module according to an implementation aspect.

In an exemplary embodiment, the first computing device 310 may receive a query related to the benchmark from the second computing device 320, and receive a query related to the benchmark from other entities other than the second computing device 320, and may also receive a query related to the benchmark from the user device 385. As an example, the query related to the benchmark may include information on a model to be benchmarked and a device in which the benchmark is to be executed. As an example, the query related to the benchmark may include information on a specific area (e.g., a part of the model) in the model to be benchmarked and the information on the device in which the benchmark is to be executed. A technique according to an exemplary embodiment of the present disclosure may allow the user to set the benchmark object for the area of the benchmark by the unit of a node constituting the model or by the unit of a block corresponding to a group of nodes rather than by the unit of the model to achieve a technical effect of being capable of solving more accurate and specific needs of the user.

In an exemplary embodiment, the first computing device 310 may provide the benchmark result or the benchmark prediction result in response to the benchmark query. For example, the first computing device 310 may provide a benchmark result or a benchmark prediction result of the artificial intelligence-based model (e.g., a learning model or a compression model created by the user).

In an exemplary embodiment, the first computing device 310 may generate benchmark results or benchmark prediction results corresponding to various types of benchmark queries. For example, the benchmark result or the benchmark prediction result may include different information according to the type of benchmark query and/or information included in the benchmark query.

In an exemplary embodiment, the first computing device 310 may receive module identification information indicating which module among the plurality of modules of the second computing device 320 triggers the benchmark operation of the first computing device 310, and provides the benchmark result or the benchmark prediction result to the second computing device 320 based on the module identification information. The benchmark result or the benchmark prediction result provided to second computing device 320 may vary depending on the module identification information. For example, the first computing device 310 may provide performance information for the entire input model to the second computing device 320 when the module identification information indicates the first module 330, and provide the performance information for the entire input model to the second computing device 320 and/or provide performance information by the unit of the block of the input model or performance information by the unit of a partial area when the module identification information indicates the second module 340.

In an exemplary embodiment, the first computing device 310 may provide, to the second computing device 320, a benchmark result for determining a target node in which the learning model corresponding to the input dataset or the converted learning model is to be executed when the module identification information indicates the first module 330. The first computing device 310 may provide, to the second computing device 320, a benchmark result including compression setting data used for generating the lightweight model corresponding to the input model when the module identification information indicates the second module 340.

In an exemplary embodiment, the first computing device 310 may correspond to an entity that manages a plurality of devices. The first computing device 310 may perform a benchmark for devices included in a device list including a first device 360, a second device 370, . . . , an N-th device 380. Here, N may correspond to a natural number. For example, the first device 360 to the N-th device 380 may be included in a candidate device list which is under the management of the first computing device 310.

In FIG. 3, it is exemplified that the first device 360, the second device 370, . . . , the N-th device 380 are included in the first computing device 310, but the first device 360, the second device 370, . . . , the N-th device 380 are present outside the first computing device 310, and may interact with each other through communication with the first computing device 310 according to an implementation aspect.

In an exemplary embodiment, the first computing device 310 may generate a benchmark result or a benchmark prediction result for at least one device among the plurality of devices in response to the benchmark query from the user device 385 and/or the benchmark query from the second computing device 320. For example, the benchmark query from the user device 385 may be input into the second computing device 320, and the benchmark query may also be transmitted to the first computing device 310 through the second computing device 320.

In an exemplary embodiment, the first computing device 310 may generate a benchmark result or a benchmark prediction result for at least one device among the plurality of devices by interacting with the converting device 390 in response to the benchmark query from the user device 385 and/or the benchmark query from the second computing device 320. In an exemplary embodiment, the converting device 390 may correspond to an entity for converting the model. For example, the converting device 390 may convert the model included in the benchmark query into a model which is executable at the target device. For example, when the conversion for the model is included in the benchmark query, the converting device 390 may perform model conversion according to the benchmark query.

As illustrated in FIG. 3, the converting device 390 may be present as a separate entity from the first computing device 310 and the second computing device 320. As another example, the converting device 390 may also operate as an entity included in the first computing device 310 and/or the second computing device 320.

In an exemplary embodiment, the benchmark result may include a result of executing (e.g., inferring) the artificial intelligence-based model at the target device. As an example, the benchmark result may include a performance measurement result which may be obtained from the target device when the artificial intelligence-based model is executed at the target device. As another example, the benchmark result may include a performance measurement result when the converted artificial intelligence-based model is executed at the target device.

In an exemplary embodiment, the benchmark prediction result may include a result predicted when executing (e.g., inferring) the artificial intelligence-based model at the target device. As an example, the benchmark result may include a predicted performance measurement result which may be obtained from the target device when the artificial intelligence-based model is executed at the target device. As another example, the benchmark result may include an expected performance measurement result when the converted artificial intelligence-based model is executed at the target device. The benchmark prediction result may be generated based on a pre-obtained benchmark result.

In an exemplary embodiment, the benchmark result and/or the benchmark prediction result may be used for various purposes, and as various forms. For example, the benchmark result and/or the benchmark prediction result may be used for determining the target device on which the model is to be executed. For example, the benchmark result and/or the benchmark prediction result may be used for generating the candidate device list corresponding to the input model. For example, the benchmark result and/or the benchmark prediction result may be used for optimization or compression for the model. For example, the benchmark result and/or a benchmark prediction result may be used for deploying the model at the target device. For example, the benchmark result may be used for generating the benchmark prediction result.

FIG. 4 exemplarily illustrates a method for providing a benchmark prediction result according to an exemplary embodiment of the present disclosure.

In an exemplary embodiment, the method illustrated in FIG. 4 may be performed by the computing device 100. As an example, the method illustrated in FIG. 4 may be performed by the first computing device 310. As another example, the method illustrated in FIG. 4 may be performed by the computing device 100 that encompasses the first computing device 310 and the second computing device 320.

Hereinbelow, an example in which steps of FIG. 4 are performed by the computing device 100 will be described in detail. It will be appreciated by those skilled in the art that some of the steps illustrated in FIG. 4 may be omitted or an additional step may be included according to the implementation aspect.

In an exemplary embodiment, the computing device 100 may obtain a benchmark query from a user input specifying a benchmark target (410).

In an exemplary embodiment, the computing device 100 may receive input data of intending to benchmark a specific model. The benchmark query may include any form of input related to the benchmark for the specific model.

For example, the benchmark query may be obtained from an input from a user. For example, the input data may include a model file which is modeled, and model type or model identification information to be benchmarked. As another example, the input data may include the model file which is modeled, and model type or model identification information corresponding to the model file. As another example, the input data may include the model file which is modeled, the model type or model identification information corresponding to the model file, and target model type or target model identification information to be benchmarked. Additionally, the input data may further include information on a device on which the benchmark for the model is to be executed.

In an exemplary embodiment, the computing device 100 may obtain information on a model to be benchmarked by parsing the benchmark query. The information on the model may include, for example, identification information of a model, a name of a model file, a software version, a framework, a size of the model, an input shape of the model, a batch size, and/or the number of channels. The computing device 100 may obtain information on a target device in which benchmarking is to be executed by parsing the benchmark query. As an example, the benchmark query may include the information on the model to be benchmarked and the information on the target device in which the benchmarking is to be executed.

In an exemplary embodiment, a user input for specifying a benchmark target may include, for example, information on a model and a device for which predicted performance information is to be obtained. In an exemplary embodiment, the user input for specifying a benchmark target may include, for example, information on a model and a device for which performance information is to be measured.

In an exemplary embodiment, the computing device 100 may provide information selecting a target device in which the benchmarking of the model is to be executed in response to the benchmark query. As an example, in the present disclosure, the target device may refer to a device in which the model is to be executed for performance measurement. As an example, in the present disclosure, the target device may refer to a device which becomes a target of predicted performance measurement. A benchmark prediction result corresponding to the target device may be obtained based on a pre-stored benchmark result for the target device. As an example, the information on the target device may include identification information of the target device, a software version related to the target device, software information which is supportable at the target device, and/or an output data type related to the target device. As a non-limited example, the identification information of the target device may be, for example, Jetson Nano, Jetson Xavier NX, Jetson TX2, Jetson AGX Xavier, Jetson AGX Orin, GPU AWS-T4, Xeon-W-2223, Raspberry Pi Zero, Raspberry Pi 2W, Raspberry Pi 3B+, Raspberry Pi Zero 4B, etc. Information for selecting the target device may include, for example, a candidate device list including a plurality of candidate devices. As an example, the candidate device list may include candidate devices which may support a model type (e.g., a model framework) corresponding to the benchmark query.

In an exemplary embodiment, the benchmark query may include model type information. The model type information may be obtained by the user input.

In an additional exemplary embodiment, the model type information may be obtained as the benchmark query is parsed. As an example, the benchmark query may include the model file, and the computing device 100 may extract model type information (e.g., the framework of the model) corresponding to the model file by parsing the model file.

In the present disclosure, the model type information may be used interchangeably with the model identification information. The model type information may include any type of information identifying the input artificial intelligence-based model. For example, the model type information may include information indicating an execution configuration of the model, such as TFLite, Onnx Runtime, OpenVINO, and Tensorrt. For example, the model type information may also include library information or software version information for the execution configuration of the model. In such an example, the model type information may be expressed as Python 3.7.3 and pillow 5.4.1 of TFLite.

In the present disclosure, the target model type information may be used interchangeably with the target model identification information. In an exemplary embodiment, the target model type information to be benchmarked may include any type of information identifying the artificial intelligence-based model for performing the benchmarking. As an example, the model type information (e.g., a model prepared by the user) included in the user input and the model type information for which benchmarking is to be performed may be different from each other. In such an example, the input data may include information on the model prepared by the user (e.g., a prepared model file) and target model type information to be benchmarked.

In an exemplary embodiment, the computing device 100 may extract corresponding model type information and/or model target type information from the input artificial intelligence-based model. The computing device 100 may obtain or extract execution configuration and/or library information of the model by parsing the input artificial intelligence-based model (e.g., the model file). For example, the computing device 100 may generate benchmark result information or benchmark prediction result information for the target device based on the obtained information on the model.

In an exemplary embodiment, the computing device 100 may also determine whether to convert the model by comparing the extracted model type information and the input target model type information. In an example, the target model type information may be different from the model type information of the input artificial intelligence-based model. In this case, the computing device 100 may obtain a converting result in which the input artificial intelligence-based model is converted to have the target model type information. The target model type information and the model type information of the input model being different may mean information on the execution configuration of the model and/or the library information for the execution configuration being different. As an example, converting may include replacing an operator included in the input model to correspond to the target model type information. As an example, converting may include changing the library information or software version of the input model to correspond to the target model type information. As an example, converting may include changing the execution configuration of the input model to an execution configuration corresponding to the target model type information. In such examples, the computing device 100 may determine whether to convert at least a part of the input model by comparing the model type information and the target model type information. For example, the computing device 100 may determine not converting a part of the input model when the model type information of the input model coincides with the target model type information and determine converting a part of the input model when the model type information of the input model is different from the target model type information.

In an additional exemplary embodiment, the computing device 100 may also determine whether to convert the model based on information related to the model and target device information. For example, the computing device 100 may determine whether to convert the model based on whether the model is supported in the target device or whether the node included in the determined model is supported in the target device. For example, the model may not be supported at the target device. In this case, the computing device 100 may determine whether to convert the model or determine whether to convert at least some of nodes included in the determined model. As another example, the computing device 100 may also determine that converting the determined model is required or determine changing the selected device to another device when the determined model is not supported in the target device.

In an exemplary embodiment, the computing device 100 may determine at least one target block to be used for obtaining a benchmark prediction result corresponding to the benchmark query among a plurality of prestored blocks based on the benchmark query (420). In an exemplary embodiment, the computing device 100 may obtain the benchmark prediction result corresponding to the benchmark query by using the benchmark result related to at least one target block (430).

In the present disclosure, the block may refer to a group of one or more nodes constituting the model. For example, it is assumed that a specific model is constituted by a first node that performs a first convolutional operation, a second node that performs a first sigmoid operation, a third node that performs a second convolutional operation, and a fourth node that performs a second sigmoid operation. Under the assumption, the block may correspond to any type of group which may be made by the first node, the second node, the third node, and the fourth node. As an example, the block may be constituted by one node of the first node, the second node, the third node, and the fourth node. As another example, the block may be constituted by a combination of two nodes among the first node, the second node, the third node, and the fourth node. As another example, the block may be constituted by a combination of three nodes among the first node, the second node, the third node, and the fourth node. As another example, the block may be constituted by the first node, the second node, the third node, and the fourth node. In such examples, when the block includes the plurality of nodes, the block may include nodes and an edge connecting the nodes.

In the present disclosure, the target block may correspond to a block to be used for generating the benchmark prediction result among the plurality of prestored blocks. For example, the computing device 100 may generate a benchmark prediction result corresponding to the benchmark query based on performance information assigned to the target block and/or performance information assigned to respective sub blocks included in the target block.

In an exemplary embodiment, the benchmark query may identify the target area in the target model to be benchmarked. The benchmark query may include a range set in a specific model. As an example, the benchmark query may include an input of selecting an area including specific nodes in a specific model. The target block corresponding to the benchmark query may be determined. The benchmark result may be generated based on the performance information assigned to the target block. The benchmark prediction result may include anticipated performance information corresponding to the identified target area when the benchmarking is performed at the target device.

In an exemplary embodiment, the benchmark query may identify a start node and an end node in the target model to be benchmarked. For example, the benchmark query may include a range from the start node to the end node to be benchmarked in a specific model. The target block corresponding to the benchmark query may be determined. The benchmark result may be generated based on the performance information assigned to the target block. In such an example, the benchmark prediction result may include anticipated performance information corresponding to a target area defined by the identified start node and the identified end node when the benchmarking is performed at the target device.

In an exemplary embodiment, the benchmark query may include a node identifier and an edge identifier in the target model to be benchmarked. For example, the benchmark query may include information identifying one or more nodes which intend to perform benchmarking in the specific model. For example, the benchmark query may include information identifying a connection relationship between the nodes which intend to perform benchmarking in the specific model. The target block corresponding to the benchmark query may be determined. The benchmark result may be generated based on the performance information assigned to the target block. In such examples, the benchmark prediction result may include anticipated performance information corresponding to a target area defined by the identified node identifier and the identified edge identifier when the benchmarking is performed in the target device.

As described above, since the technique according to an exemplary embodiment of the present disclosure may not provide the benchmark result or the benchmark prediction result by the unit of the model, and may provide the benchmark result or the benchmark prediction result by the unit of a specific area selected by the user in the model, a technical effect that more specific and efficient information may be provided to the user may be achieved. Additionally, the technique according to an exemplary embodiment of the present disclosure may provide more accurate information determining which area performs compression in a specific model to increase compression efficiency.

In the present disclosure, the anticipated performance information may mean anticipated information related to a model or node-wise performance for each of target devices, which is measured in advance. As a non-limited example, the anticipated performance information may include anticipated latency information. In such an example, the anticipated performance information may be generated for each block. For example, the anticipated performance information may be generated for each block and for each device.

In an exemplary embodiment, the computing device 100 may determine a query node and a query edge included in the benchmark query, determine a target node corresponding to the query node and a target edge corresponding to the query edge, and determine a block including the target node and the target edge among a plurality of prestored blocks as a target block to be used for obtaining a benchmark prediction result corresponding to the benchmark query.

In an exemplary embodiment, the query node and the query edge may be generated from information included in the benchmark query. For example, the benchmark query may include information on a combination and a configuration constituted by a node and an edge to be benchmarked. The computing device 100 may determine ranges of nodes to be benchmarked and/or a connection relationship between the nodes based on the information included in the benchmark query. The nodes and the edges constituting the range to be benchmarked may be referred to as the query node and the query edge.

In an exemplary embodiment, the target node and the target edge may correspond to the node and the edge included in the target block. The target block including the target node and the target edge among the plurality of prestored blocks may be determined based on the configuration of the query node and the query edge. For example, identification information of the node included in the benchmark query may be used for determining the query node, and the connection relationship between the nodes included in the benchmark query may be used for determining the query edge. Based on the performance information assigned to the target block constituted by the target node and the target edge or the performance information assigned to the sub block of the target block, a benchmark prediction result corresponding to the target node and the target edge (i.e., corresponding to the benchmark query) may be generated.

In an exemplary embodiment, the computing device 100 determines a similarity with the query node and the query edge included in the benchmark query with respect to each of the plurality of prestored blocks, and assigns a priority for the plurality of prestored blocks based on the similarity to determine at least one target block to be used for obtaining the benchmark prediction result corresponding to the benchmark query. For example, the identification information of the node(s) to be benchmarked and the connection relationship between the nodes may be determined from the benchmark query, and the query node and the query edge may be determined based on the identification information and the connection relationship. The computing device 100 may determine similarities between the query node and the query edge, and a plurality of selected (or predetermined) blocks. For example, the similarity may be determined at least partially based on an attribute of the node and a connection relationship between nodes. For example, the computing device 100 may determine a similarity of each of the plurality of prestored blocks with the benchmark query, based on whether there being a node having attribute information corresponding to attribute information of the query node, whether there being a node having identification information corresponding to the identification information of the query node whether there being a node capable of replacing a function of the node according to the identification information or the attribute information of the query node, whether there being nodes of a number corresponding to the number of query nodes, and/or whether there being a connection relationship corresponding to a connection relationship between the query node and the query edge. The similarity may be expressed in a form of a quantitative score or as a vectorized form in a vector space. For example, the computing device 100 may assign the priority for the plurality of blocks in an order of a high similarity. As an example, a candidate list of target blocks may be provided in the order of the high similarity. As another example, blocks in which the similarity exceeds a selected (or predetermined) threshold similarity may be provided as the candidate list of the target blocks. As another example, a selected (or predetermined) number of blocks may be provided as the target blocks in the order of the high similarity. In an exemplary embodiment, the target block corresponding to the benchmark query may be determined based on user selection on the candidate list of the target blocks or an additional algorithm of the computing device 100.

In an exemplary embodiment, the computing device 100 may determine whether a configuration of the node and the edge corresponding to the configuration of the query node and the query edge included in the benchmark query being present in one block among the plurality of prestored blocks, and determine a block including the corresponding configuration of the node and the edge as the target block to be used for obtaining the benchmark prediction result corresponding to the benchmark query when the configuration of the node and the edge corresponding to the configuration of the query node and the query edge included in the benchmark query is present in one block among the plurality of prestored blocks.

In an exemplary embodiment, the computing device 100 may determine a combination of two or more blocks for generating the configuration corresponding to the configuration of the query node and the query edge among the plurality of prestored blocks when the configuration of the node and the edge corresponding to the configuration of the query node and the query edge included in the benchmark query is not present in one block among the plurality of prestored blocks. Likewise, the technique according to an exemplary embodiment of the present disclosure may also determine the combination of two or more blocks as the target block. For example, it is assumed that the configuration of the query node and the query edge corresponds to a serial connection of node A, node B, node C, and node D, and the plurality of prestored blocks includes a first block representing a connection of node A and node B and a second block representing a connection of node C and node D. Under the assumption, since one block corresponding to the benchmark query is not present, the computing device 100 may determine a combination of the first block and the second block as the target block. In such an example, the computing device 100 combines benchmark results assigned to two or more determined blocks, respectively to obtain the benchmark prediction result corresponding to the benchmark query. For example, the computing device 100 combines (e.g., aggregates) the performance information assigned to the first block and the performance information assigned to the second block to generate the benchmark prediction result corresponding to the benchmark query.

In an exemplary embodiment, the computing device 100 may determine a block including a target node having an attribute which is mutually replaceable with the attribute of the query node as the target block to be used for obtaining a benchmark prediction result corresponding to the benchmark query among the plurality of prestored blocks when the configuration of the node and the edge corresponding to the configuration of the query node and the query edge included in the benchmark query is not present in the plurality of prestored blocks. In an exemplary embodiment, the target node having the attribute which is mutually replaceable with the attribute of the query node among the plurality of prestored blocks may correspond to a node having data with a shape which is quantitatively replaceable with a shape of data of the query node. The computing device 100 determines, based on a quantitative difference value between the attributes of the target node and the query node, a replacement value between the target node in the target block, and the query node, and applies the replacement value to the benchmark result assigned to the target block to obtain the benchmark prediction result corresponding to the benchmark query. As an example, the replacement value may include a difference value or a ratio value between a quantitative size value corresponding to the shape of the data of the query node and a size value corresponding to the shape of the data of the target node. For example, it may be determined that the query node included in the benchmark query uses data having a shape or a size of 64×3×6×6 as input data through the attribute of the query node. In this case, the computing device 100 may identify a target node having an input attribute having a shape or a size which is replaceable with the input data of the query node. For example, the computing device 100 may determine a target node having an input attribute with a shape or a size of 32×3×6×6 as a target node having an attribute which is mutually replaceable with the attribute of the query node. The block including the target node may be determined as the target block. In such an example, the computing device 100 may generate the benchmark prediction result corresponding to the benchmark query based on a quantitative difference or a quantitative relationship between the attribute of the query node and the attribute of the target node. For example, it can be seen that the quantitative difference in attribute (e.g., an input attribute or a size of the input data) between the query node and the target node is doubled. In such an example, by using a scheme of multiplying the performance information (e.g., a latency of 15 ms) assigned to the target node or assigned to the target block by 2, a latency of 30 ms may be generated as the benchmark prediction result corresponding to the benchmark query.

In an exemplary embodiment, each of the plurality of prestored blocks may include at least one sub block. For example, the sub blocks in one block are present as sub blocks of a number corresponding to the number of selectable cases for N nodes included in one block or the number of combinationable cases, and the N may correspond to a selected (or predetermined) natural number. For example, the sub block in one block may have, when nodes included in one block is set as a universal set, the number of cases corresponding to sub sets of the universal set. In an exemplary embodiment, a benchmark result corresponding to each of prestored blocks and/or prestored sub blocks may be obtained through pre-measurement, and the benchmark result may be mapped to each of the prestored blocks and/or the prestored sub blocks.

In an exemplary embodiment, the benchmark result or the benchmark prediction result may include a latency for a case where the target block is executed in the target device. As an example, the benchmark result of each of the plurality of blocks (or the benchmark result of each of the plurality of sub-blocks) previously performed for each of the plurality of devices may be assigned to each of the plurality of blocks (or each of the plurality of sub-blocks). Here, the benchmark result may include latency information. In a technique according to an exemplary embodiment of the present disclosure, the benchmark prediction result corresponding to the benchmark query may be generated using benchmark results for a plurality of blocks or a plurality of sub-blocks. The technique according to an exemplary embodiment of the present disclosure may determine a target block (or target sub-block) corresponding to an input benchmark query, obtain a benchmark result corresponding to the target block or target sub-block, and generate the benchmark prediction result corresponding to the benchmark query in a more efficient and more accurate scheme by using the obtained benchmark result.

In an exemplary embodiment, the benchmark result or the benchmark prediction result may include preprocessing time information required for preprocessing inference of the target block in the target device, inference time information required for inferring the target block in the target device, preprocessing memory usage information used for preprocessing the inference of the target block in the target device, inference memory usage information used for inferring the target block in the target device, quantitative information related to an inference time, which is obtained as the target block is repeatedly inferred at a selected (or predetermined) number of times in the target device, and/or quantitative information related to memory use for each of the NPU, the CPU, and the GPU, which is obtained as the target block is inferred in the target device.

In an exemplary embodiment, the preprocessing time information may include time information required for preprocessing before the inference operation is performed such as calling the block, the node, and/or the model. Additionally, the preprocessing time information may also include quantitative information (e.g., a minimum value, a maximum value, and/or an average value of a time required for pre-inference) related to a time required for the pre-inference when the pre-inference is repeated at a selected (or predetermined) number of times for activation of the GPU, etc., before measuring a value for inference.

In an exemplary embodiment, the inference time information as time information required during an inference process may be used to encompass minimum time information, maximum time information, average time information, and/or median time information among time information required for an initial inference operation for the block, the node, and/or the model and/or inference time information when the block, the node, and/or the model is inferred repeatedly at the selected (or predetermined) number of times, for example. Additionally, for example, in a situation in which the CPU receives and processes an operation which may not be processed by the NPU, the NPU becomes an idle state, and the inference time information may include a first cycle value when the NPU becomes the idle state. Additionally, the inference time information may also include a second cycle value when the NPU performs inference and/or a third cycle value obtained by aggregating the first cycle value and the second cycle value.

In an exemplary embodiment, the benchmark result or the benchmark prediction result may include total time information obtained by aggregating the preprocessing memory usage information and the quantitative information related to the inference time.

In an exemplary embodiment, the benchmark result or the benchmark prediction result may additionally include a RAM usage, a ROM usage, a total memory usage, and/or a quantitative value for an SRAM area used by the NPU.

In an exemplary embodiment, when a plurality of benchmark prediction results are generated as a plurality of devices are selected as target devices, the computing device 100 may sort the plurality of benchmark prediction results based on latency. For example, the benchmark prediction results may be sorted and output in an order of a smallest latency. In an additional exemplary embodiment, when there are benchmark results corresponding to a plurality of devices in which the latency is within or is the same as a selected (or predetermined) similar range, the benchmark prediction results may be sorted additionally based on a memory usage and/or a CPU occupancy. Sorting the benchmark prediction results may efficiently assist the user in making decisions about which device to execute the benchmark on. The benchmark prediction result may include, for example, a data structure in the form of a table.

In the present disclosure the benchmark prediction result for the benchmark query may be obtained based on various algorithms using the target block.

In an exemplary embodiment, the computing device 100 may determine whether a block having a configuration which is the same as the configuration constituted by the node and the edge included in the benchmark query among a plurality of blocks is present. When the corresponding block is present, the computing device 100 may use a benchmark result pre-measured for the determined block as a benchmark prediction result corresponding to the benchmark query. For example, the computing device 100 may confirm whether the block having the configuration which is the same as the configuration of the benchmark query is present when receiving a benchmark query in which each of node A, node B, node C, and node D is connected to one edge in series. When there is the block having the configuration in which each of node A, node B, node C, and node D is connected to one edge in series, the computing device 100 may use the benchmark result pre-measured for the corresponding block as the benchmark prediction result for the benchmark query.

In an exemplary embodiment, the computing device 100 may also store a node-wise benchmark result in the block and an edge-wise benchmark result in the block. In such an exemplary embodiment, the computing device 100 may obtain an identifier of each of the nodes included in the benchmark query, and obtain the benchmark result for the node in the block prestored, which corresponds to the obtained identifier of the node. Further, the computing device 100 may obtain an identifier of each of the edges included in the benchmark query, and obtain the benchmark result for the edge in the block prestored, which corresponds to the obtained identifier of the edge. By such a scheme, the computing device 100 may generate the benchmark prediction result corresponding to the benchmark query by a scheme of dividing the benchmark query into the node and the edge, and combining a prestored benchmark result corresponding to the divided node and a prestored benchmark result corresponding to the divided edge. For example, it is assumed that the benchmark query includes node A, node B, node C, a first edge connecting node A and node B, and a second edge connecting node A and node C. Under the assumption, the computing device 100 may generate the benchmark prediction result for the benchmark query by a scheme of combining benchmark result A pre-measured for node A, benchmark result B pre-measured for node B, benchmark result C pre-measured for node C, benchmark result D pre-measured for the first edge connecting node A and node B, and benchmark result E pre-measured for the second edge connecting node A and node C. In such an example, the computing device 100 may measure the benchmark result by the unit of the node and by the unit of the edge, and use a measured result for responding to a subsequent query. In such an example, the block may correspond to the node and/or the edge.

In an exemplary embodiment, the computing device 100 may pre-measure a benchmark result for each of sub sets of the prestored block. The pre-measured benchmark result may be made into a database. The computing device 100 may generate the block constituted by node A, node B, node C, the first edge connecting node A and node B, and the second edge connecting node B and node C. The computing device 100 may measure the benchmark result corresponding to the block by executing the block in various devices. Further, the computing device 100 may measure the benchmark result corresponding to each of the sub blocks corresponding to the sub sets of the block. For example, the computing device 100 executes node A, node B, node C, a combination of node A and node B, a combination of node B and node C, a combination of node A and node C, and a combination of nodes A, B, and C constituting one block in various devices, respectively to measure a latency measured during a benchmarking process for each of the sub blocks. The measured latency may be made into the database. In such a situation, the computing device 100 may use a latency (i.e., the pre-measured latency corresponding to the combination of node B and node C) corresponding to the sub block of the prestored block as the benchmark prediction result corresponding to the benchmark query in response to reception of the benchmark query constituted by node B and node C. As a non-limited example, such an exemplary embodiment may be utilized when the block corresponding to the benchmark query is not present.

In an exemplary embodiment, the computing device 100 may generate the benchmark prediction result through the combination of the pre-stored block or the combination of the pre-stored sub blocks. For example, the computing device 100 may generate the benchmark prediction result corresponding to the benchmark query by a scheme of combining (e.g., aggregating) a first benchmark result assigned to a first block constituted by node A and node B and a second benchmark result assigned to a second block constituted by node C and node D in response to reception of the benchmark query constituted by node A, node B, node C, and node D.

In an exemplary embodiment, the computing device 100 may generate the benchmark prediction result by a scheme of applying a mathematical operation for the benchmark result corresponding to the pre-stored block or the pre-stored sub block. When the node and/or the edge corresponding to the benchmark query are/is not present in the pre-stored block or sub block, the computing device 100 may determine a node and/or an edge which is replaceable with the node and/or the edge as the target node and/or the target edge. In an exemplary embodiment, when there is no pre-stored node having a kernel size which is the same as a kernel size of the node included in the benchmark query, the computing device 100 may determine a first node having a most similar kernel size as the node included in the benchmark query as the target node. In an exemplary embodiment, when there is no pre-stored node having a kernel size which is the same kernel size as the node included in the benchmark query, the computing device 100 may determine a second node having the kernel size as the node included in the benchmark query as the target node among the pre-stored nodes when a mathematical operation (e.g., multiplication, division, square, etc.) is applied. As a non-limited example, although an expression of the sub block as a sub concept of the block is used for convenience of description, it will be apparent to those skilled in the art that the sub block may replace a concept of the block according to an implementation aspect.

In an exemplary embodiment, the computing device 100 may also generate the benchmark prediction result corresponding to the benchmark query through the combination of various algorithms.

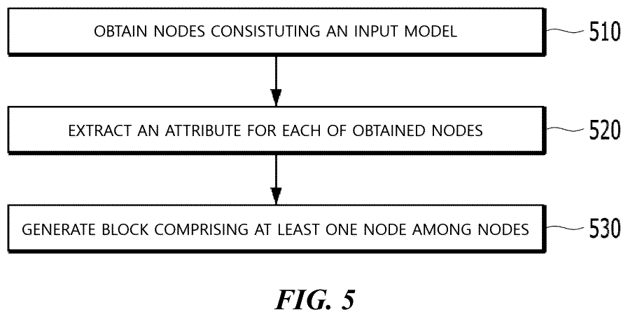

FIG. 5 exemplarily illustrates a method for generating a block used for providing a benchmark prediction result according to an exemplary embodiment of the present disclosure.

In an exemplary embodiment, the computing device 100 may perform a benchmark by obtaining respective nodes constituting a model, grouping the nodes, and specifying an inference option to a target device for each group. A result of the benchmark performed as such may be converted into a database and used to generate a benchmark prediction result in the future.

In an exemplary embodiment, the computing device 100 may obtain a plurality of nodes constituting an input model (510).

For example, the computing device 100 may divide the input model into operation units so that at least one operation corresponds to one node. In such a scheme, the computing device 100 may divide one model into a plurality of nodes for each of the plurality of models. For example, within the input model, a plurality of nodes may be divided into node identifier units, node attribute units, node function units, and/or node operator units. When a plurality of nodes for a model are obtained, the computing device 100 may express the connection relationship between the nodes as an edge. Edges representing the connection relationships between nodes may be placed between nodes based on a scheme in which each node operates within the model.

In an exemplary embodiment, the computing device 100 may extract an attribute for each of the plurality of obtained nodes (520).

In an exemplary embodiment, the attribute for each of the nodes that may constitute the model may be extracted by the computing device 100. In an exemplary embodiment, the attribute for the node may mean a feature or characteristic for defining the node. In an exemplary embodiment, the attribute may include any form of identification information to identify the node. As another example, a second node that has the same as at least some of the plurality of attributes of the first node may be identified as the same node as the first node. As another example, a second node having all the same attribute as the plurality of attributes of the first node may be identified as the same node as the first node.

As a non-limited example, the attribute may include an input attribute representing information input into the node and/or an input relationship of the node, an operation attribute representing an operation scheme in a node, and/or an output attribute representing information output from a node and/or an output relationship.

In an exemplary embodiment, the attribute may include an input attribute including previous connection information of the node within the model, an identifier of the node, and a data shape of the node. For example, the input attribute may include identification information for a previous node connected to the corresponding node through an edge. For example, the input attribute may include an identifier that may define the corresponding node. For example, the input attribute may include a size of input data. The size of the input data may have a matrix form such as 3×3×12, 12×12×64, etc. As a non-limited example, the larger the size of the input data, the greater the latency when performing the benchmark. For example, the input attribute may include the type of input data of the node, such as 32 bits, 4 bits, or 8 bits.

In an exemplary embodiment, the attribute may include an output attribute including next connection information of the node within the model, an identifier of the node, and a data shape of the node. For example, the output attribute may include identification information for a next node connected to the corresponding node through the edge. For example, the output attribute may include an identifier that may define the corresponding node. For example, the output attribute may include a size of output data. As a non-limited example, the larger the size of the output data, the greater the latency when performing the benchmark. For example, the output attribute may include the type of output data of the node, such as 32 bits, 4 bits, or 8 bits.

In an exemplary embodiment, the attribute may include an operation attribute including at least one of a data shape of the node in the model, a weight of the node, a bias of the node, a stride of the node, a pad of the node, a dilation of the node, and group information within the node. As a non-limited example, the operation attribute may represent an attribute related to an operation scheme or function of the node.

In an exemplary embodiment, the above-described attribute may be used to determine a target block (or target sub-block) from the benchmark query. For example, blocks with more than 50% of the attributes being the same may be identified as the same block. As another example, blocks with the same predefined specific attributes among the attributes may be identified as the same block. As yet another example, blocks with all of the same attributes may be identified as the same block.

In an exemplary embodiment, the identification information of the node may be generated through a combination of the various attributes described above. In another exemplary embodiment, nodes may also be identified as the same node when the combination of some of the various attributes described above is the same. For example, nodes with the same input attributes and the same output attributes may be identified as the same nodes. As another example, nodes with the same input attributes, the same operation attributes, and the same output attributes may be identified as the same nodes. As yet another example, nodes with the same data shape among input attributes, the same data shape among output attributes, and the bias among operation attributes may be identified as the same nodes.

In an exemplary embodiment, the computing device 100 may generate a block including at least one node among a plurality of nodes (530).

For example, the computing device 100 may generate the block including at least one node among the plurality of nodes, based on a scheme in which at least one node included in the generated block corresponds to a subset of the plurality of nodes. For example, computing device 100 may group nodes having a maximum selected (or predetermined) number of connectivity from a minimum of one node (e.g., received from a user device). The computing device 100 may extract a selected (or predetermined) number of edges from the grouped nodes and generate nodes connected through the extracted edges as one block. For example, the computing device 100 may store nodes and edges grouped into one block in a DB in units of the block.

For example, the computing device 100 may generate a block including one or more nodes by combining the obtained plurality of nodes using a selected (or predetermined) combination scheme. For example, the selected (or predetermined) combination scheme may include a combination scheme in which a result of combining the obtained plurality of nodes corresponds to a subset of the obtained plurality of nodes.

In an exemplary embodiment, a benchmark may be performed in units of a device for each of the generated blocks and/or for each of the sub-blocks within the generated blocks. Depending on a results of performing the benchmark, performance measurement information may be generated in units of the device and the block (or in units of the sub-block).

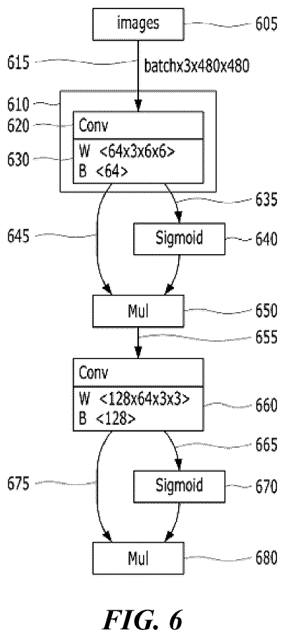

FIG. 6 exemplarily illustrates a data structure of the block according to an exemplary embodiment of the present disclosure.

FIG. 6 visually illustrates an operation process of a specific model. The model illustrated in FIG. 6 may include a first node 630 that receives an image 605. The computing device 100 may extract attributes for respective nodes 630, 640, 650, 660, 670, and 680 illustrated in FIG. 6. As a non-limited example, the attributes may include previous connection information, an input data type, an input data shape, a kernel shape, a filter shape, a pad, stride, a weight, a bias, a group, a dilation, next connection information, an output data type, and/or an output data shape.

In an exemplary embodiment, the computing device 100 may generate the block by using at least one of the nodes 630, 640, 650, 660, 670, and 680 and the edges 615, 635, 645, 655, 665, and 675 illustrated in FIG. 6. One node may also constitute the block, and a combination of a plurality of nodes and an edge((s) connecting the same may also constitute the block.

In an exemplary embodiment, a first node 630 may correspond to a Convolutional layer 620. The Convolutional layer 620 corresponding to identification information or an identifier of the first node 630 may be included in an input attribute of the first node 630. A first edge 615 of the first node 630 may be included in the input attribute of the first node 630. The first edge 615 may include previous connection information of the first node 630. The first edge 615 may connect the image 605 and the first node 630. The first node 630 may receive input data in a shape of 3×480×480 in units of a batch. The shape or size of the input data may be included in the input attribute of the first node 630.

In an exemplary embodiment, as illustrated in FIG. 6, the first node 630 may have a value of a weight (W) and a value of a bias (B) as the operation attribute.

In an exemplary embodiment, a second node 640 may correspond to a sigmoid layer. The first node 630 may be connected to the second node (e.g., a Sigmoid node) 640 through an edge 635. The edge 635 may be included in an output attribute of the first node 630. The edge 635 may be included in an input attribute of the second node 640.

In an exemplary embodiment, a fourth node 660 is the Convolutional layer corresponding to the first node 630. As an example, because the identification information of the fourth node 660 and the first node 630 corresponds to each other, the fourth node 660 and the first node 630 may be identified as corresponding nodes. As another example, since an edge 655, one of the input attributes of the fourth node 660, is different from the edge 615, one of the input attributes of the first node 630, the fourth node 660 and the first node 630 may be identified as different nodes. As yet another example, since the operation attributes (W and B) of the fourth node 660 and the operation attributes (W and B) of the first node 630 are different from each other, the fourth node 660 and the first node 630 may be identified as different nodes. As still yet another example, since the output attributes (665 and 675) of the fourth node 660 and the output attributes (635 and 645) of the first node 630 are different from each other, the fourth node 660 and the first node 630 may be identified as different nodes. As further still another example, since the output attributes (665 and 675) of the fourth node 660 and the output attributes (635 and 645) of the first node 630 indicate nodes of the same identifier, the fourth node 660 and the first node 630 may also be identified as the same node. As described above, identity between nodes (or identity between blocks) may be determined using at least one attribute among the attributes assigned to the nodes.

The example illustrated in FIG. 6 includes the first node 630, the second node 640, the third node 655, the fourth node 660, the fifth node 670, and the sixth node 680, and edges thereof. The computing device 100 may generate the block by using at least one node of the first node 630, the second node 640, the third node 655, the fourth node 660, the fifth node 670, and the sixth node 680.

In the example in FIG. 6, the computing device 100 shows that the first node 630 among the plurality of nodes is generated as a block 610. Depending on an implementation aspect, those skilled in the art will fully recognize that any combination of nodes among the plurality of nodes 630, 640, 650, 660, 670, and 680 may correspond to one block.

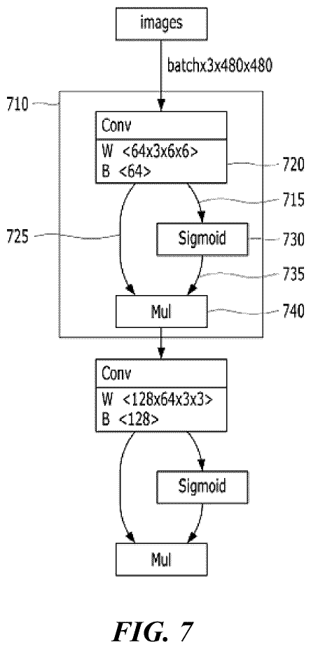

FIG. 7 exemplarily illustrates a data structure of the block according to an exemplary embodiment of the present disclosure.

FIG. 7 illustrates a block 710 constituted by a first node 720, a second node 730, a third node 740, a first edge 715, a second edge 725, and a third edge 735.

In an exemplary embodiment, the computing device 100 may generate a benchmark result corresponding to the block 710 by executing the block 710 on various devices. In an exemplary embodiment, the computing device 100 may generate benchmark results for respective sub-blocks (e.g., 720, 730, and 740) constituting the block 710 for various devices and/or generate a benchmark result for any combination of the sub-blocks (e.g., 720, 730, and 740).

In such an example, when a benchmark query is received with a configuration including a Convolutional layer where W corresponds to 32×3×6×6 and B corresponds to 32, and a connection of the second node 730 and the third node 740, the computing device 100 may determine whether a block identical to the benchmark query exists among the plurality of blocks. When it is determined that there is no block identical to the benchmark query among the plurality of blocks, the computing device 100 may determine, as the target block, the block 710 where only the first node 720 is different and connection relationships between the remaining nodes and the edges are the same. In order to match the first node 720 in the target block 710 with the Convolutional layer of the benchmark query, the computing device 100 may determine to multiply the attribute (e.g., operation attribute) of the first node 720 by 2. Accordingly, a substitution value between the first node 720 and the Convolutional layer may be determined to correspond to a double relationship. As an example, the computing device 100 may generate the benchmark prediction result corresponding to the benchmark query by a scheme of aggregating a benchmark result value for each of the second node 730 and the third node 740 and a value obtained by multiplying a benchmark result for the first node 720 by 2 in the target block 710. As another example, the computing device 100 may generate the benchmark prediction result corresponding to the benchmark query by a scheme of aggregating a benchmark result value pre-measured for a sub-block corresponding to the second node 730, the third node 740, and the edge 735 connecting the second node 730 and the third node 740, and the value obtained by multiplying the benchmark result for the first node 720 by 2 in the target block 710.

In an additional exemplary embodiment, the computing device 100 may provide a candidate device list for recommending target devices which are to perform the benchmark.

In an exemplary embodiment, a candidate device may be used to determine a target device to be benchmarked among a plurality of devices. Among the candidate devices included in the candidate device list, the target device on which the benchmark will be performed may be determined based on user input and/or based on model information on which the benchmark will be performed.

For example, among devices under the management of the computing device 100, devices that may support an input artificial intelligence-based model or block may be included in the candidate device list.

For example, devices with a memory space exceeding the size of an artificial intelligence-based model or the size of a specific block may be determined as candidate devices.

In an exemplary embodiment, the computing device 100 may deliver the candidate device list to an entity that requests the benchmark. The target device on which the benchmark will be performed may be determined according to the user's selection on the candidate device list.

In an exemplary embodiment, a candidate node list may include identification information for each of the candidate devices and/or predicted latency information for each of the candidate devices.

In an exemplary embodiment, the predicted latency information may include an inference time predicted for each model (e.g., block) of each device. It may be indicated that as a value of the predicted latency information is smaller, the inference time is shorter. Accordingly, since the value of the predicted latency may be interpreted as a performance indicator for the combination of an artificial intelligence-based model (e.g., block) and a device, the computing device 100 may provide a list of candidate devices sorted based on the size of the predicted latency information. In such an example, a list of candidate devices sorted in descending order of the size of the latency information may be provided.

In an exemplary embodiment, the identification information for the candidate device may include hardware information corresponding to the candidate device. For example, the identification information may include not only a product name corresponding to the hardware, but also installed execution environment information, library information for the execution environment, power mode information, fan mode information, temperature information of a current board, and/or power usage information of the current board.

In an exemplary embodiment, the power mode information may be determined based on how many CPU cores are used. For example, when all CPU cores are used, the power mode information will be determined as MAX, and may also be determined in a scheme of quantitatively expressing usage, such as 30 W, 20 W, 15 W, and 10 W. For example, the larger the quantitative amount of the power mode information, the lower the latency may be. As another example, when the power mode is MAX, the latency may be lower than that of another device that does not use the power mode.

In an exemplary embodiment, the fan mode information may be expressed in the form of information indicating the intensity of the fan, such as Null, Quiet, and Cool. As an example, when the fan mode is Quiet, the temperature of the board may be lowered more than when the fan mode is Null, so there is a high possibility of lower latency. As an example, when the fan mode is the Cool mode, the temperature of the board may be lowered more than when another mode, so there is the high possibility of lower latency.

In an exemplary embodiment, the library information may indicate library information required to install execution environment (e.g., runtime) information installed on a specific device. Depending on the characteristics of the device, a plurality of execution environments may be included, and accordingly, the library information may also be compatible with the plurality of execution environments.

In an exemplary embodiment, the power usage of the current board may represent a power usage obtained from a power measurement sensor connected to the device. It may be interpreted that the smaller the power usage value of the current board, the higher the usability of the node.

In an exemplary embodiment, the sorting order of candidate nodes included in the candidate device list may be determined based on the size of the predicted latency information. The computing device 100 may provide a list of candidate devices sorted based on the size of predicted latency information. In such an example, a list of candidate devices sorted in descending order of the size of the latency information may be provided.

In an additional exemplary embodiment, the sorting order of the candidate devices may be determined based on factors such as a memory usage and CPU occupancy. For example, the sorting order of the candidate devices may be determined based additionally on the memory usage and the CPU occupancy as well as the predicted latency information. In this example, when a difference in size of the predicted latency information between a first candidate device and a second candidate device among the candidate devices is within a selected (or predetermined) threshold range, the sorting order between the first candidate device and the second candidate device may be determined based on the memory usage and the CPU occupancy of the first candidate device and the second candidate device. As an example, when the predicted latencies are the same, additional sorting may be performed based on current memory (e.g., RAM) usage and CPU occupancy.

In an additional exemplary embodiment, the computing device 100 may perform sorting by considering additional factors in the case of a specific device such as the Jetson series. For example, for specific types of devices such as the Jetson series, separate sorting for the devices may be performed additionally. As another example, the computing device 100 sorts specific types of devices based on predicted latency when sorting the specific types of devices with other types of devices, but when devices corresponding to the type have predicted latency values within a similar range, perform sorting by additionally considering a Power field and/or a Fan field. As an example, the computing device 100 may perform sorting in order of the most Power fields by additionally considering a factor corresponding to the Power field. As an example, when the Power field is the same or within a selected (or predetermined) threshold range for the specific device such as the Jetson series, the computing device 100 may perform additional sorting for devices in order of a larger fan's operation size based on the size or intensity of the fan's operation.

As described above, for devices that do not have a significant difference in predicted latency information, the sorting order of the candidate devices may be determined by considering additional factors. In providing the candidate device list as such, the candidate devices are sorted in a form that allows the user to intuitively check the predicted performance, so the user may more easily and efficiently check the predicted performance of the devices on the candidate device list and more efficiently determine the target device.

In an exemplary embodiment, the computing device 100 may link a converting operation in the process of generating the candidate device list. For example, computing device 100 may determine whether the model and/or block included in the benchmark query may be executed on the determined target node, and determine, based on the determination, whether to convert the model and/or block included in the benchmark query. Converting may be performed by the computing device 100 or a converting result may also be obtained through an external converting device. The computing device 100 may obtain sub latency information corresponding to each of a plurality of nodes. For example, one node may correspond to one sub latency. Here, the sub latency information may be calculated for each of the candidate devices. The plurality of nodes may exist in the model, and the computing device 100 may measure or determine a sub-latency that occurs when each node is executed on a specific target device. The computing device 100 may generate predicted latency information of a target model for each of the candidate devices based on sub latency information of the plurality of nodes. For example, the computing device 100 may obtain predicted latency information corresponding to the model by aggregating sub latencies corresponding to the nodes included in the model, respectively. The computing device 100 may provide a candidate device list including the predicted latency information and the identification information of the candidate devices.

In an exemplary embodiment, a plurality of nodes may be included within the artificial intelligence-based model. The node may correspond to an action of the artificial intelligence-based model. Different operations or different actions within the model may be represented by different nodes. As an example, a node corresponding to Conv2D representing a Convolutional operation for a 2D image may be determined as a different node from a node corresponding to Conv3D representing a Convolutional operation for a 3D image.

In an exemplary embodiment, the computing device 100 may generate the candidate device list using a latency table that matches each of the plurality of nodes and devices for each model.

In an exemplary embodiment, when the latency table exists, the computing device 100 does not measure the performance of each of the candidate devices in the process of generating the candidate device list, but may obtain the predicted performance information for each of the candidate nodes by using the latency table. When the latency table does not exist, the computing device 100 may measure the performance of each candidate device in the process of generating the candidate device list and generate a candidate device list including the measured performance.

In an exemplary embodiment, the benchmark prediction result may include any form of performance information when a block or node corresponding to the benchmark query is executed on the target device in addition to latency. For example, the benchmark prediction result may include power mode information, fan mode information, temperature information of the current board, and/or power usage information of the current board. The power mode information may be determined based on how many CPU cores are used. For example, when all CPU cores are used, the power mode information will be determined as MAX, and may also be determined in a scheme of quantitatively expressing usage, such as 30 W, 20 W, 15 W, and 10 W. For example, the larger the quantitative amount of the power mode information, the lower the latency may be. As another example, when the power mode is MAX, the latency may be lower than that of another node that does not use the power mode. The fan mode information may be expressed in the form of information indicating the intensity of the fan, such as Null, Quiet, Cool, and Max. As an example, when the fan mode is Quiet, the temperature of the board may be lowered more than when the fan mode is Null, so there is a high possibility of lower latency. As an example, when the fan mode is the Cool mode, the temperature of the board may be lowered more than when another mode, so there is the high possibility of lower latency. The power usage of the current board may represent a power usage obtained from a power measurement sensor connected to the device. It may be interpreted that the smaller the power usage value of the current board, the higher the usability of the device.

In an exemplary embodiment, the benchmark prediction result may include a first type of quantitative information related to time and a second type of quantitative information related to memory use.

In an exemplary embodiment, the performance information obtained as the target model (or target block) is executed in at least one target device may include preprocessing time information required for preprocessing inference of the target block in at least one target device, inference time information required for inferring the target block in at least one target device, preprocessing memory usage information used for preprocessing the inference of the target block in at least one target device, inference memory usage information used for inferring the target block in at least one target device, quantitative information related to an inference time, which is obtained as the target block is repeatedly inferred at a selected (or predetermined) number of times in at least one target device, and/or quantitative information related to memory use for each of the NPU, the CPU, and the GPU, which is obtained as the target block is inferred in at least one target device.

In an exemplary embodiment, the preprocessing time information may include time information required for preprocessing before the inference operation is performed such as calling the model. Additionally, the preprocessing time information may also include quantitative information (e.g., a minimum value, a maximum value, and/or an average value of a time required for pre-inference) related to a time required for the pre-inference when the pre-inference is repeated at a selected (or predetermined) number of times for activation of the GPU, etc., before measuring a value for inference.

In an exemplary embodiment, the inference time information as time information required during an inference process may be used to encompass minimum time information, maximum time information, average time information, and/or median time information among the inference time information among time information required for an initial inference operation for the model when the mode is inferred repeatedly at the selected (or predetermined) number of times, for example. Additionally, for example, in a situation in which the CPU receives and processes an operation which may not be processed by the NPU, the NPU becomes an idle state, and the inference time information may include a first cycle value when the NPU becomes the idle state. Additionally, the inference time information may also include a second cycle value when the NPU performs inference and/or a third cycle value obtained by aggregating the first cycle value and the second cycle value.

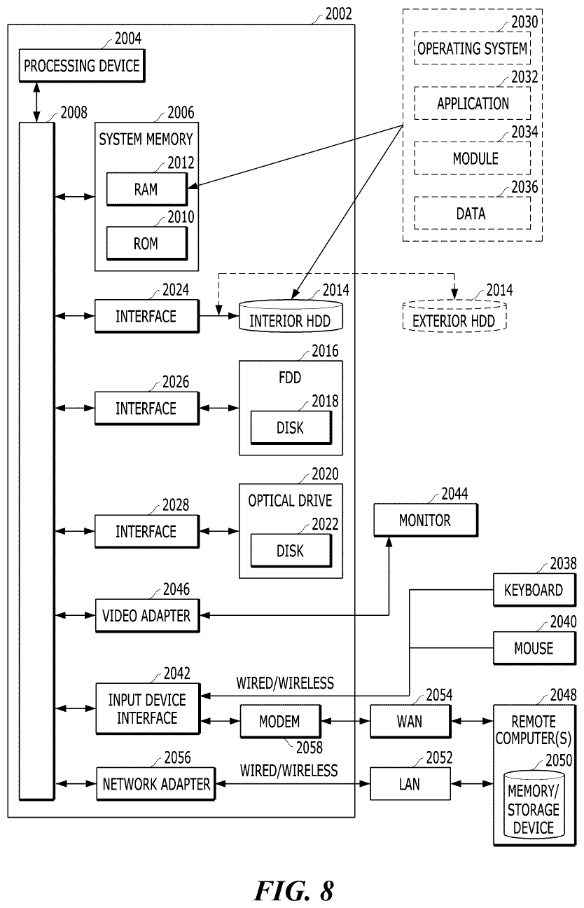

FIG. 8 is a schematic view of a computing environment of the computing device 100 according to an exemplary embodiment of the present disclosure.

In the present disclosure, the component, the module, or the unit includes a routine, a procedure, a program, a component, and a data structure that perform a specific task or implement a specific abstract data type. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computing device, a mini computer, and a main frame computer.

The embodiments described in the present disclosure may also be implemented in a distributed computing environment in which selected (or predetermined) tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a selected (or predetermined) method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or selected (or predetermined) other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2002 is shown and the computer 2002 includes a processing device 2004, a system memory 2006, and a system bus 2008. The computer 200 in the present disclosure may be used intercompatibly with the computer device 100. The system bus 2008 connects system components including the system memory 2006 (not limited thereto) to the processing device 2004. The processing device 2004 may be a selected (or predetermined) processor among various commercial processors. A dual processor and other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (for example, EIDE and SATA), a magnetic floppy disk drive (FDD) 2016 (for example, for reading from or writing in a mobile diskette 2018), SSD and an optical disk drive 2020 (for example, for reading a CD-ROM disk 2022 or reading from or writing in other high-capacity optical media such as the DVD). The hard disk drive 2014, the magnetic disk drive 2016, and the optical disk drive 2020 may be connected to the system bus 2008 by a hard disk drive interface 2024, a magnetic disk drive interface 2026, and an optical drive interface 2028, respectively. An interface 2024 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 2002, the drives and the media correspond to storing of selected (or predetermined) data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the selected (or predetermined) media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached in the RAM 2012. It will be well appreciated that the present disclosure may be implemented in operating systems which are commercially usable or a combination of the operating systems.

A user may input instructions and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058, is connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that an illustrated network connection is exemplary and other means configuring a communication link among computers may be used.

The computer 2002 performs an operation of communicating with selected (or predetermined) wireless devices or entities which are disposed and operated by the wireless communication, for example, the printer, a scanner, a desktop and/or a portable computer, a portable data assistant (PDA), a communication satellite, selected (or predetermined) equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for providing a benchmark prediction result, performed by a computing apparatus, comprising:
obtaining a benchmark query specifying a target of a benchmark;
determining at least one target block to be used to obtain the benchmark prediction result corresponding to the benchmark query among pre-stored blocks based on the benchmark query, wherein the blocks comprise a node identifying a function or an operation constituting a model, and an edge connecting nodes; and
obtaining the benchmark prediction result corresponding to the benchmark query, using a benchmark result related to the determined at least one target block.

2. The method of claim 1, wherein the benchmark query identifies a target area within a target model to be benchmarked, and the benchmark prediction result comprises predicted performance information corresponding to the identified target area when a benchmark is performed on a target device.

3. The method of claim 1, wherein the benchmark query identifies a start node and an end node within a target model to be benchmarked, and the benchmark prediction result comprises predicted performance information corresponding to a target area defined by the identified start node and the identified end node when the benchmark is performed on a target device.

4. The method of claim 1, wherein the benchmark query comprises a node identifier and an edge identifier within a target model to be benchmarked, and the benchmark prediction result comprises predicted performance information corresponding to a target area defined by the node identifier and the edge identifier when the benchmark is performed on a target device.

5. The method of claim 1, wherein the determining the at least one target block comprises:
determining a query node and a query edge included in the benchmark query;
determining a target node corresponding to the query node and a target edge corresponding to the query edge; and
determining a block comprising the target node and the target edge among the pre-stored blocks, as a target block to be used to obtain the benchmark prediction result corresponding to the benchmark query.

6. The method of claim 1, wherein the determining the at least one target block comprises:
determining similarity between each of the pre-stored blocks and a query node and a query edge included in the benchmark query; and
determining the at least one target block to be used to obtain the benchmark prediction result corresponding to the benchmark query, by assigning priority to the pre-stored blocks based on the determined similarity.

7. The method of claim 6, wherein the similarity is determined at least partially based on a connection relationship between nodes and an attribute of each node.

8. The method of claim 1, wherein the determining the at least one target block comprises:
determining whether a configuration of a node and an edge corresponding to a query configuration of a query node and a query edge included in the benchmark query exists in a single block of the pre-stored blocks;
determining a block comprising the configuration corresponding to the query configuration, as a target block to be used to obtain the benchmark prediction result corresponding to the benchmark query, when the configuration corresponding to the query configuration exists in the single block of the pre-stored blocks; and
determining a combination of two or more blocks for generating the configuration corresponding to the query configuration among the pre-stored blocks, when the configuration corresponding to the query configuration does not exist in the single block of the pre-stored blocks.

9. The method of claim 8, wherein the obtaining the benchmark prediction result corresponding to the benchmark query comprises,
obtaining the benchmark prediction result corresponding to the benchmark query by combining benchmark results assigned to each of two or more blocks.

10. The method of claim 1, wherein the determining the at least one target block comprises,
determining a block comprising a target node having an attribute interchangeable with a query attribute of the query node among the pre-stored blocks, as a target block to be used to obtain the benchmark prediction result corresponding to the benchmark query, when a configuration of a node and an edge corresponding to a query configuration of a query node and a query edge included in the benchmark query does not exist in the pre-stored blocks.

11. The method of claim 10, wherein the target node having the attribute interchangeable with the query attribute of the query node among the pre-stored blocks corresponds to a node having data of a shape quantitatively interchangeable with a data shape of the query node.

12. The method of claim 10, wherein the obtaining the benchmark prediction result corresponding to the benchmark query comprises:
determining a substitution value between the target node within the determined target block and the query node; and
obtaining the benchmark prediction result corresponding to the benchmark query, by applying the substitution value to a benchmark result assigned to the target block.

13. The method of claim 12, wherein the substitution value comprises a difference value or ratio value between a quantitative size value corresponding to a data shape of the query node and a quantitative size value corresponding to a data shape of the target node.

14. The method of claim 1, wherein each of the pre-stored blocks comprises at least one sub block, the number of the at least one sub block within a single block corresponds the number of selectable cases or combinable cases for N nodes included in the single block, and N is a predetermined natural number.

15. The method of claim 1, wherein the pre-stored blocks are obtained based on:
obtaining a plurality of nodes constituting an inputted model;
extracting an attribute for each of the obtained nodes; and
generating a block comprising at least one node among the plurality of nodes.

16. The method of claim 15, wherein the generating the block comprises,
generating the block comprising at least one node among the plurality of nodes, based on a manner in which at least one node in the generated block belongs to a subset of the obtained nodes.

17. The method of claim 15, wherein the attribute comprises at least one of:
an input attribute comprising previous connection information of a node, an identifier of a node and a data shape of a node;
an output attribute comprising next connection information of a node, an identifier of a node and a data shape of a node; and
an operation attribute comprising at least one of: a data shape of a node, a weight of a node, a bias of a node, a stride of a node, a pad of a node, a dilation of a node, and group information within a node.

18. The method of claim 15, wherein a benchmark result of each of the plurality of blocks for each of a plurality of devices is assigned to each of the plurality of blocks, and the benchmark result comprises latency information.

19. A computer program stored in a non-transitory computer readable medium, wherein the computer program allows a computing apparatus to perform following operations to provide a benchmark prediction result when executed by the computing apparatus, and wherein the operations comprise:
obtaining a benchmark query specifying a target of a benchmark;
determining at least one target block to be used to obtain the benchmark prediction result corresponding to the benchmark query among pre-stored blocks based on the benchmark query, wherein the blocks comprise a node identifying a function or an operation constituting a model, and an edge connecting nodes; and
obtaining the benchmark prediction result corresponding to the benchmark query, using a benchmark result related to the determined at least one target block.

20. A computing apparatus for providing a benchmark prediction result, comprising:
at least one processor; and
a memory,
wherein the at least one processor:
obtains a benchmark query specifying a target of a benchmark;
determines at least one target block to be used to obtain the benchmark prediction result corresponding to the benchmark query among pre-stored blocks based on the benchmark query, wherein the blocks comprise a node identifying a function or an operation constituting a model, and an edge connecting nodes; and
obtains the benchmark prediction result corresponding to the benchmark query, using a benchmark result related to the determined at least one target block.
